(19) United States
(12) Patent Application Publication
(10) Pub. No.: US 2026/0112690 A1
(43) Pub. Date: Apr. 23, 2026

(54) METHOD FOR PRODUCING SOLID ELECTROLYTE MATERIAL

(71) Applicant: Panasonic Intellectual Property Management Co., Ltd., Osaka (JP)

(72) Inventors: Masashi SAKAIDA, Hyogo (JP); Kazufumi MIYATAKE, Osaka (JP)

(21) Appl. No.: 19/424,330

(22) Filed: Dec. 18, 2025

Related U.S. Application Data
(63) Continuation of application No. PCT/JP2024/018752, filed on May 21, 2024.

(30) Foreign Application Priority Data
Jun. 29, 2023 (JP) 2023-107595

(51) Int. Cl. H01M 10/0562; H01M 10/052

(52) U.S. Cl. CPC H01M 10/0562; H01M 10/052; H01M 2300/008

(57) ABSTRACT

A method for producing a solid electrolyte material of the present disclosure is a method for producing a solid electrolyte material including Li, Ti, Al, and F, the method including pulverizing a mixture including one or more compounds each having composition different from that of the solid electrolyte material and including Li, Ti, Al, and F, and a solvent, and drying a pulverized product obtained through the pulverization. The one or more compounds include Li₂TiF₆.

This application is a Continuation of PCT/JP2024/018752 filed on May 21, 2024, which claims foreign priority of Japanese Patent Application No. 2023-107595 filed on Jun. 29, 2023, the entire contents of both of which are incorporated herein by reference.

### BACKGROUND OF THE INVENTION

### 1. Field of the Invention

The present disclosure relates to a method for producing a solid electrolyte material.

### 2. Description of Related Art

JP 2011-129312 A discloses a method for producing a sulfide solid electrolyte material. JP 2008-277170A discloses an inorganic solid electrolyte of a compound including lithium and a halogen such as LiBF₄, as an inorganic solid electrolyte having lithium ion conductivity.

### SUMMARY OF THE INVENTION

The present disclosure aims to expand a process window in a method for producing a solid electrolyte material including Li, Ti, Al, and F.

A method for producing a solid electrolyte material of the present disclosure is a method for producing a solid electrolyte material including Li, Ti, Al, and F, the method including: pulverizing a mixture including one or more compounds each having composition different from that of the solid electrolyte material and including Li, Ti, Al, and F, and a solvent; and drying a pulverized product obtained through the pulverization, wherein the one or more compounds include Li₂TiF₆.

According to the present disclosure, it is possible to expand a process window in a method for producing a solid electrolyte material including Li, Ti, Al, and F.

### BRIEF DESCRIPTION OF THE DRAWINGS

FIG. 1A is a flowchart showing an example of a method for producing a solid electrolyte material according to a first embodiment.

FIG. 1B is a flowchart showing another example of the method for producing a solid electrolyte material according to the first embodiment.

FIG. 2 shows a cross-sectional view of a battery according to a second embodiment.

FIG. 3 shows a cross-sectional view of a battery of Modification Example 1.

FIG. 4 shows a cross-sectional view of a battery of Modification Example 2.

FIG. 5 shows a schematic diagram of a pressure-molding die for use in evaluating the ionic conductivity of a solid electrolyte material.

FIG. 6 is a graph showing a Cole-Cole plot obtained by impedance measurement on a solid electrolyte material of Example 1.

FIG. 7 shows changes in ionic conductivity with changes in pulverization time for solid electrolyte materials of Examples 1 to 6 and Comparative Examples 1 to 3.

FIG. 8 is a graph showing initial discharge characteristics of batteries of Example 4 and Comparative Example 4.

### DETAILED DESCRIPTION OF THE INVENTION

Hereinafter, embodiments of the present disclosure will be described with reference to the drawings. The following embodiments are each an example, and the present disclosure is not limited to the following embodiments.

### First Embodiment

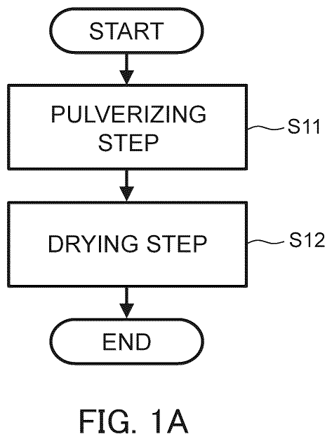

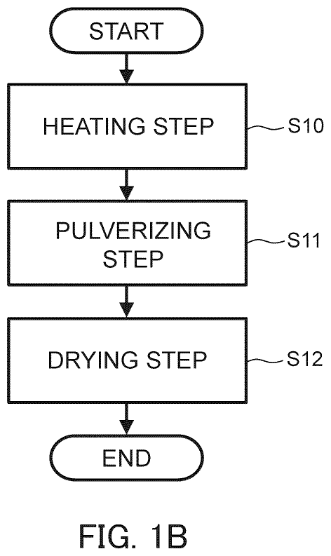

FIG. 1A is a flowchart showing an example of a method for producing a solid electrolyte material according to a first embodiment.

The method for producing a solid electrolyte material according to the first embodiment is a method for producing a solid electrolyte material including Li, Ti, Al, and F. The production method includes a pulverizing step S11 and a drying step S12. The pulverizing step S11 is conducted before the drying step S12.

In the pulverizing step S11, a mixture M including one or more compounds each including Li, Ti, Al, F, and a solvent is pulverized. The one or more compounds each have composition different from that of the solid electrolyte material to be produced.

In the drying step S12, a pulverized product obtained through the pulverizing step S11 is dried. Thus, the solvent included in the pulverized product is removed.

The one or more compounds used in the pulverizing step S11 include Li₂TiF₆.

With the above configuration, it is possible to expand the process window, for example, the range of the optimal pulverization time.

A method in which a slurry obtained by pulverizing a raw material in a solvent is heated is known as one of the methods for producing a solid electrolyte material including Li, Ti, Al, and F. From the viewpoint of production efficiency, it is desired that a solid electrolyte material having a high ionic conductivity be obtained in the shortest possible pulverization time. In addition, as the pulverization time becomes longer, the deterioration of the raw material further progresses, and the ionic conductivity tends to decrease. This is inferred to be because as the pulverization time lengthens, the amount of oxygen included in the raw material increases, and the increase causes a side reaction between the raw material and the solvent. From the viewpoint of production efficiency, it is desired that the progression of the decrease in the ionic conductivity of the solid electrolyte material be suppressed. That is, it is desired that a high ionic conductivity be maintained over the longest possible pulverization time. Thus, there is a demand for expanding the process window, for example, the range of the optimal pulverization time, in the method for producing a solid electrolyte material including Li, Ti, Al, and F. As a result of extensive studies, the present inventors have found that in the case where Li₂TiF₆ is used as one of the raw materials, the range of the optimal pulverization time can be expanded as compared to the case where, for example, TiF₄ is used as one of the raw materials. This is conceived to be because Li₂TiF₆ has thermal stability and chemical stability higher than those of TiF₄.

In the present embodiment, the mixture M includes one or more compounds each including Li, Ti, Al, and F, and a solvent. The mixture M may consist of one or more compounds each including Li, Ti, Al, and F, and a solvent.

In the present embodiment, the one or more compounds include a Ti-containing compound. Examples of the Ti-containing compound include Li₂TiF₆ and (NH₄)₂TiF₆. The one or more compounds may include Li₂TiF₆ as the Ti-containing compound. With the above configuration, it is possible to expand the process window.

The one or more compounds may include a Li-containing compound. The Li-containing compound is a compound having composition different from that of Li₂TiF₆. With the above configuration, it is possible to expand the process window.

Examples of the Li-containing compound include LiF, LiOH, and Li₂CO₃. The one or more compounds may include LiF as the Li-containing compound. With the above configuration, it is possible to expand the process window.

The one or more compounds may include an Al-containing compound. With the above configuration, it is possible to expand the process window.

Examples of the Al-containing compound include AlF₃, (NH₄)₃AlF₆, and Li₃AlF₆. The one or more compounds may include AlF₃ as the Al-containing compound. With the above configuration, it is possible to expand the process window.

The one or more compounds may include three or more compounds including a Ti-containing compound, a Li-containing compound, and an Al-containing compound. The one or more compounds may be three compounds consisting of a Ti-containing compound, a Li-containing compound, and an Al-containing compound.

In the pulverizing step S11, the mixture M including Li₂TiF₆, LiF, and AlF₃, and a solvent may be pulverized.

In the present embodiment, a pulverization process in the pulverizing step S11 is a wet pulverization process. The wet pulverization process is a method for pulverizing a material mainly by shear force and friction force after mixing the material with a solvent. In the wet pulverization process, the surfaces of particles of the material are scraped off, and small particles are generated.

The solvent used in the pulverizing step S11 may be an organic solvent or an inorganic solvent such as water, but is desirably an organic solvent.

The organic solvent may include a compound having an ester group. In this case, the one or more compounds each exhibit extremely favorable dispersibility in the above organic solvent. Therefore, with the above configuration, it is possible to enhance the ionic conductivity of the solid electrolyte material.

The organic solvent may include at least one selected from the group consisting of γ-butyrolactone, propylene carbonate, butyl acetate, and tetralin. In this case, the one or more compounds each exhibit extremely favorable dispersibility in the above organic solvent. Therefore, with the above configuration, it is possible to enhance the ionic conductivity of the solid electrolyte material.

A pulverization method in the pulverizing step S11 is not particularly limited. For example, a ball mill, a pot mill, a bead mill, a V-type mixer, a double cone mixer, or an automatic mortar may be used. For example, a raw material powder and a solvent may be placed in a mixer such as a planetary ball mill and mixed while being micronized.

A pulverization time in the pulverizing step S11 may be appropriately set in accordance with the pulverization method. For example, when a planetary ball mill is used, the ionic conductivity of the solid electrolyte material can reach 3×10⁻⁶ μS/m at a pulverization time of 10 hours. Further, even when the pulverization time exceeds 45 hours, the ionic conductivity of the solid electrolyte can maintain 3×10⁻⁶ μS/m or more.

In the present embodiment, when the pulverizing step S11 is conducted such that the BET specific surface area of the solid electrolyte material is 25 m²/g or more, the expansion of the process window is easily achieved. That is, the pulverizing step S11 may be conducted such that the BET specific surface area of the solid electrolyte material is 25 m²/g or more. The upper limit of the BET specific surface area of the solid electrolyte material obtained through the pulverizing step S11 is not particularly limited. The upper limit of the BET specific surface area of the solid electrolyte material may be, for example, 100 m²/g, 70 m²/g, 50 m²/g, 45 m²/g, 40 m²/g, or 35 m²/g.

The BET specific surface area of the solid electrolyte material may be determined by, for example, converting the data of an adsorption isotherm, which is obtained by a gas adsorption method using nitrogen gas, by the Brunauer-Emmett-Teller (BET) method.

In the drying step S12, the solvent may be removed from the pulverized product by heating the pulverized product under an inert gas atmosphere. A heating temperature (atmosphere temperature) is, for example, 50° C. or higher and 300° C. or lower.

In the present embodiment, in the drying step S12, the solvent may be removed from the pulverized product by drying under reduced pressure. The drying under reduced pressure is a method for removing the solvent from the pulverized product under a pressure atmosphere lower than atmospheric pressure. The pressure atmosphere lower than atmospheric pressure is, for example, −0.01 MPa or less in gauge pressure. In the drying step S12, the solvent may be removed from the pulverized product by vacuum drying. The vacuum drying is, for example, a method for removing the solvent from the pulverized product at a pressure equal to or lower than a vapor pressure at a temperature lower than the boiling point of the solvent by 20° C. The heating temperature of the pulverized product in the drying under reduced pressure or the vacuum drying is, for example, 50° C. or higher and 300° C. or lower.

FIG. 1B is a flowchart showing another example of the method for producing a solid electrolyte material according to the first embodiment.

As shown in FIG. 1B, the method for producing a solid electrolyte material according to the first embodiment may further include a heating step S10. The heating step S10 is conducted before the pulverizing step S11.

In the heating step S10, a mixture M1 including two or more compounds including TiF₄ and LiF, and a solvent is heated. Thus, Li₂TiF₆ is synthesized.

In the pulverizing step S11, a mixture M2 including a composition obtained through the heating step S10 and an Al-containing compound is pulverized. The composition obtained through the heating step S10 includes Li₂TiF₆. The Al-containing compound may include AlF₃.

The example shown in FIG. 1B is different from the example shown in FIG. 1A in that Li₂TiF₆ is synthesized in advance through the heating step S10.

In the drying step S12, the pulverized product obtained through the pulverizing step S11 is dried. Thus, the solvent included in the pulverized product is removed.

The above configuration can also expand the process window, for example, the range of the optimal pulverization time.

In the present embodiment, the mixture M1 includes two or more compounds including TiF₄ and LiF, and a solvent. The mixture M1 may consist of two or more compounds including TiF₄ and LiF, and a solvent.

In the present embodiment, the mixture M2 includes the composition obtained through the heating step S10 and an Al-containing compound. The mixture M2 may consist of the composition obtained through the heating step S10 and an Al-containing compound.

The pulverizing step S11 and the drying step S12 in the example shown in FIG. 1B correspond to the pulverizing step S11 and the drying step S12 in the example shown in FIG. 1A, respectively. Therefore, detailed descriptions are omitted.

In the example shown in FIG. 1B, in the heating step S10, a mixture M3 including three or more compounds including TiF₄, LiF, an Al-containing compound, and a solvent may be heated. Thus, Li₂TiF₆ may be synthesized. In this case, in the pulverizing step S11, the composition obtained through the heating step S10 is pulverized. The composition obtained through the heating step S10 includes Li₂TiF₆ and an Al-containing compound. That is, in the example shown in FIG. 1B, the Al-containing compound may be added in the heating step S10.

The above configuration can also expand the process window, for example, the range of the optimal pulverization time.

In the present embodiment, the mixture M3 includes three or more compounds including TiF₄, LiF, and an Al-containing compound, and a solvent. The mixture M3 may consist of three or more compounds including TiF₄, LiF, and an Al-containing compound, and a solvent.

Hereinafter, the solid electrolyte material produced by the method for producing a solid electrolyte material according to the first embodiment is referred to as a “first solid electrolyte material”. The first solid electrolyte material includes Li, Ti, Al, and F. The first solid electrolyte material can have a high ionic conductivity.

The first solid electrolyte material includes F, and hence can have high oxidation resistance. This is because F has a high oxidation-reduction potential. Meanwhile, F has a high electronegativity, and hence has a relatively strong bond with Li. As a result, a solid electrolyte material including Li and F generally tends to have a low lithium ion conductivity. For example, LiBF₄ disclosed in JP 2008-277170 A has a low ionic conductivity of 6.67×10⁻⁹ S/cm. In contrast, the first solid electrolyte material further includes Ti and Al in addition to Li and F, and hence can have a high ionic conductivity of, for example, 7×10⁻⁹ S/cm or more.

The first solid electrolyte material can be used, for example, to obtain a battery having excellent charge and discharge characteristics. Examples of the battery include an all-solid-state battery. The all-solid-state battery may be a primary battery or a secondary battery.

It is desired that the first solid electrolyte material be free of sulfur. A solid electrolyte material free of sulfur is excellent in safety because the solid electrolyte material does not generate hydrogen sulfide even when exposed to the atmosphere. The sulfide solid electrolyte disclosed in JP 2011-129312 A may generate hydrogen sulfide when exposed to the atmosphere.

The first solid electrolyte material may further include an anion other than F. Examples of the anion include Cl, Br, I, O, and Se. With the above configuration, the ionic conductivity of the first solid electrolyte material is enhanced.

A ratio R of the amount of substance of F to the total sum of the amounts of substance of anions of the first solid electrolyte material may be 0.50 or more. The ratio R may be 0.50 or more and 1.0 or less. With the above configuration, the oxidation resistance of the first solid electrolyte material is enhanced.

The anion constituting the first solid electrolyte material may be F alone. That is, the ratio R may be 1.0. With the above configuration, the oxidation resistance of the first solid electrolyte material is further enhanced.

The first solid electrolyte material may consist substantially of Li, Ti, Al, and F. Here, the phrase “the first solid electrolyte material consists substantially of Li, Ti, Al, and F” means that the ratio (i.e., mole fraction) of the sum of the amounts of substance of Li, Ti, Al, and F to the total of the amounts of substance of all the elements constituting the first solid electrolyte material is 90% or more. In an example, the ratio (i.e., mole fraction) may be 95% or more. The first solid electrolyte material may consist of Li, Ti, Al, and F.

The first solid electrolyte material may contain an element unavoidably incorporated. Examples of the element include hydrogen, oxygen, and nitrogen. Such an element can be present in a raw material powder of the first solid electrolyte material or in an atmosphere for producing or storing the first solid electrolyte material.

The first solid electrolyte material may be represented by the following formula (1).

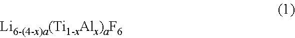

In the formula (1), 0<x<1 and 0<a≤1.5 are satisfied. A solid electrolyte material having such composition has a high ionic conductivity.

In the formula (1), 0.1×0.9 may be satisfied to increase the ionic conductivity.

In the formula (1), 0.1×0.7 may be satisfied to further increase the ionic conductivity.

The upper and lower limits of the range of x in the formula (1) can be defined by any combination selected from the numerical values of 0.1, 0.3, 0.4, 0.5, 0.6, 0.67, 0.7, 0.8, and 0.9.

In the formula (1), 0.8≤a≤1.2 may be satisfied to increase the ionic conductivity.

The upper and lower limits of the range of a in the formula (1) can be defined by any combination selected from the numerical values of 0.8, 0.9, 0.94, 1.0, 1.06, 1.1, and 1.2.

The first solid electrolyte material may be represented by the following formula (2). In Formula (2), α, β, γ, and δ are each independently a value greater than 0.

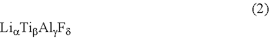

The first solid electrolyte material may be represented by the following formula (3). In the formula (3), M is at least one selected from the group consisting of Zr, Ni, Fe, and Cr, m is a valence of M2, and 0.1<x<0.9, 0≤y<0.1, 0≤z<0.1, and 0.8<b≤1.2 are satisfied.

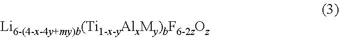

In the formula (3), when M includes a plurality of types of elements, m is a total value of products of composition ratios of the respective elements and valences of the elements. For example, when M includes an element Me1 and an element Me2, a composition ratio of the element Me1 is a1 and a valence of the element Me1 is m1, and a composition ratio of the element Me2 is a2 and a valence of the element Me2 is m2, m is represented by m1×a1+m2×a2.

To further increase the ionic conductivity, in the above solid electrolyte, the ratio of the amount of substance of Li to the total of the amounts of substance of Ti and Al may be 1.12 or more and 5.07 or less.

The first solid electrolyte material may be Li_{2.7}Ti_{0.3}Al_{0.7}F₆.

The first solid electrolyte material may be crystalline or amorphous.

The first solid electrolyte material may include a crystalline phase represented by the formula (1).

The shape of the first solid electrolyte material is not limited. Examples of the shape include an acicular shape, a spherical shape, and an ellipsoidal shape. The first solid electrolyte material may be particulate. The first solid electrolyte material may have a pellet or plate shape.

Subsequently, an example of the production method in the present embodiment when the first solid electrolyte material is Li_{2.7}Ti_{0.3}Al_{0.7}F₆ will be described below.

First, one or more compounds each including Li, Ti, Al, and F and having composition different from that of the first solid electrolyte material, which are weighed so as to have the target composition, and a solvent are mixed while being micronized in a mixer.

In an example, LiF, Li₂TiF₆, and AlF₃ are prepared in an approximate molar ratio of 2.1:0.3:0.7. The raw material powders may be prepared in a molar ratio adjusted in advance so as to cancel out a composition change that may occur in a synthesis process. The raw material powders and the solvent may be loaded into a mixer such as a planetary ball mill and mixed while being micronized. That is, a process with a wet ball mill may be conducted. The raw material powders may be mixed before being loaded into the mixer.

When the balls are separated after the mixing, a slurry in which particles are dispersed is obtained. The solvent is removed by drying the slurry at a temperature in accordance with the boiling point of the solvent used. Thus, the first solid electrolyte material having the composition represented by Li_{2.7}Ti_{0.3}Al_{0.7}F₆ is obtained. The first solid electrolyte material may be pulverized with a mortar or the like.

The first solid electrolyte material may be fired in a vacuum or in an inert atmosphere. The firing is conducted, for example, at 100° C. or higher and 300° C. or lower for 1 hour or longer. To suppress a composition change during the firing, the firing may be conducted in a sealed container such as a quartz tube.

The solvent for use in the wet ball mill may include at least one selected from the group consisting of γ-butyrolactone (GBL), propylene carbonate, butyl acetate, and tetralin. From the viewpoint of the dielectric constant of the solvent, N-methyl-2-pyrrolidone (NMP) may be used as the solvent.

### Second Embodiment

A second embodiment will be described below. Matters described in the first embodiment are omitted as appropriate.

A battery according to the second embodiment includes a positive electrode, a separator part, and a negative electrode. The separator part is arranged between the positive electrode and the negative electrode.

At least one selected from the group consisting of the positive electrode, the negative electrode, and the separator part includes the first solid electrolyte material. The above configuration enables the battery to have excellent charge and discharge characteristics.

The separator part may be a solid electrolyte layer or a separator impregnated with an electrolytic solution.

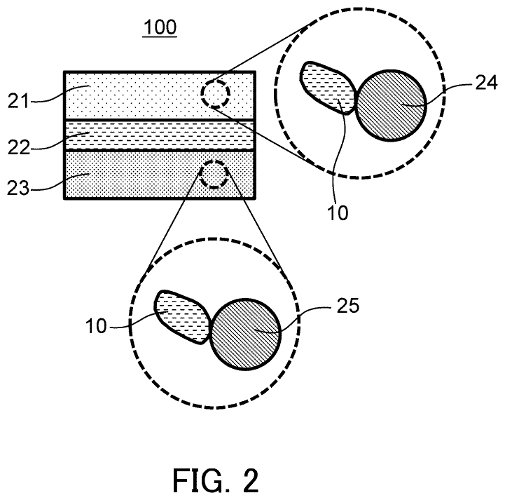

FIG. 2 shows a cross-sectional view of a battery 100 according to the second embodiment.

The battery 100 according to the second embodiment includes a positive electrode 21, a solid electrolyte layer 22, and a negative electrode 23. The solid electrolyte layer 22 is arranged between the positive electrode 21 and the negative electrode 23. In the battery 100, the separator part is the solid electrolyte layer 22.

The positive electrode 21 includes a positive electrode active material 24 and a solid electrolyte 10. The solid electrolyte layer 22 includes an electrolyte material. The negative electrode 23 includes a negative electrode active material 25 and the solid electrolyte 10.

The solid electrolyte 10 may include the first solid electrolyte material. The solid electrolyte 10 may be a particle including the first solid electrolyte material as a main component. The particle including the first solid electrolyte material as a main component means a particle in which a component included in the largest amount in terms of molar ratio is the first solid electrolyte material. The solid electrolyte 10 may be a particle consisting of the first solid electrolyte material.

The positive electrode 21 includes a material capable of occluding and releasing metal ions (e.g., lithium ions). The material is, for example, the positive electrode active material 24.

Examples of the positive electrode active material 24 include a lithium-containing transition metal oxide, a transition metal fluoride, a polyanion, a fluorinated polyanion material, a transition metal sulfide, a transition metal oxyfluoride, a transition metal oxysulfide, and a transition metal oxynitride. Examples of the lithium-containing transition metal oxide include Li(Ni,Co,Mn)O₂, Li(Ni,Co,Al)O₂, and LiCoO₂.

In the present disclosure, “(A,B,C)” means “at least one selected from the group consisting of A, B, and C”.

The shape of the positive electrode active material 24 is not limited to a specific shape. The positive electrode active material 24 may be particulate. The positive electrode active material 24 may have a median diameter of 0.1 μm or more and 100 μm or less. In the case where the positive electrode active material 24 has a median diameter of 0.1 μm or more, the positive electrode active material 24 and the solid electrolyte 10 can be favorably dispersed in the positive electrode 21. The above configuration enhances the charge and discharge characteristics of the battery 100. In the case where the positive electrode active material 24 has a median diameter of 100 μm or less, the diffusion rate of lithium inside the positive electrode active material 24 is enhanced. The above configuration enables the battery 100 to operate at a high output.

The positive electrode active material 24 may have a larger median diameter than the solid electrolyte 10 has. The above configuration can favorably disperse the positive electrode active material 24 and the solid electrolyte 10 in the positive electrode 21.

To enhance the energy density and output of the battery 100, the ratio of the volume of the positive electrode active material 24 to the total of the volume of the positive electrode active material 24 and the volume of the solid electrolyte 10 in the positive electrode 21 may be 0.30 or more and 0.95 or less.

On at least a portion of the surface of the positive electrode active material 24, a coating layer may be formed. For example, before mixing of the positive electrode active material 24 with a conductive additive and a binder, the coating layer can be formed on the surface of the positive electrode active material 24. Examples of the coating material included in the coating layer include a sulfide solid electrolyte, an oxide solid electrolyte, and a halide solid electrolyte. In the case where the solid electrolyte 10 includes a sulfide solid electrolyte, the coating material may include the first solid electrolyte material in order to suppress oxidative decomposition of the sulfide solid electrolyte. In the case where the solid electrolyte 10 includes the first solid electrolyte material, the coating material may include an oxide solid electrolyte in order to suppress oxidative decomposition of the first solid electrolyte material. Lithium niobate, which is excellent in high-potential stability, may be used as the oxide solid electrolyte. The suppression of the oxidative decomposition can suppress an increase in the overvoltage of the battery 100.

To enhance the energy density and output of the battery 100, the positive electrode 21 may have a thickness of 10 μm or more and 500 μm or less.

The negative electrode 23 includes a material capable of occluding and releasing metal ions (e.g., lithium ions). The material is, for example, the negative electrode active material 25.

Examples of the negative electrode active material 25 include a metal material, a carbon material, an oxide, a nitride, a tin compound, and a silicon compound. The metal material may be a simple substance of metal or an alloy. Examples of the metal material include lithium metal and a lithium alloy. Examples of the carbon material include natural graphite, coke, partially graphitized carbon, a carbon fiber, spherical carbon, artificial graphite, and amorphous carbon. From the viewpoint of capacity density, suitable examples of the negative electrode active material include silicon (i.e., Si), tin (i.e., Sn), a silicon compound, and a tin compound.

The negative electrode active material 25 may be selected in view of the reduction resistance of the solid electrolyte material included in the negative electrode 23. For example, in the case where the negative electrode 23 includes the first solid electrolyte material, the negative electrode active material 25 may be a material capable of occluding and releasing lithium ions at 0.27 V or more versus lithium. Examples of such a negative electrode active material include a titanium oxide, an indium metal, and a lithium alloy. Examples of the titanium oxide include Li₄TiO₁₂, LiTi₂O₄, and TiO₂. The use of the above negative electrode active material can suppress reductive decomposition of the first solid electrolyte material included in the negative electrode 23. As a result, the charge and discharge efficiency of the battery 100 can be enhanced.

The shape of the negative electrode active material 25 is not limited to a specific shape. The negative electrode active material 25 may be a particle. The negative electrode active material 25 may have a median diameter of 0.1 μm or more and 100 μm or less. In the case where the negative electrode active material 25 has a median diameter of 0.1 μm or more, the negative electrode active material 25 and the solid electrolyte 10 can be favorably dispersed in the negative electrode 23. The above configuration enhances the charge and discharge characteristics of the battery 100. In the case where the negative electrode active material 25 has a median diameter of 100 μm or less, the diffusion rate of lithium inside the negative electrode active material 25 is enhanced. The above configuration enables the battery 100 to operate at a high output.

The negative electrode active material 25 may have a larger median diameter than the solid electrolyte 10 has. The above configuration can favorably disperse the negative electrode active material 25 and the solid electrolyte 10 in the negative electrode 23.

To enhance the energy density and output of the battery 100, the ratio of the volume of the negative electrode active material 25 to the total of the volume of the negative electrode active material 25 and the volume of the solid electrolyte 10 in the negative electrode 23 may be 0.30 or more and 0.95 or less.

To enhance the energy density and output of the battery 100, the negative electrode 23 may have a thickness of 10 μm or more and 500 μm or less.

The solid electrolyte layer 22 includes an electrolyte material. The electrolyte material is, for example, a solid electrolyte material. The solid electrolyte material may include the first solid electrolyte material. The above configuration enables the battery 100 to operate at a high output.

The solid electrolyte layer 22 may include 50 mass % or more of the first solid electrolyte material. The solid electrolyte layer 22 may include 70 mass % or more of the first solid electrolyte material. The solid electrolyte layer 22 may include 90 mass % or more of the first solid electrolyte material. The solid electrolyte layer 22 may consist only of the first solid electrolyte material.

At least one selected from the group consisting of the positive electrode 21, the solid electrolyte layer 22, and the negative electrode 23 may include a second solid electrolyte material having composition different from that of the first solid electrolyte material for the purpose of enhancing the ionic conductivity, chemical stability, and electrochemical stability.

The solid electrolyte layer 22 may include the second solid electrolyte material. The first solid electrolyte material and the second solid electrolyte material may be uniformly dispersed in the solid electrolyte layer 22.

The solid electrolyte layer 22 may consist only of the second solid electrolyte material.

The second solid electrolyte material may be a halide solid electrolyte.

Examples of the halide solid electrolyte include Li₂MgX₄, Li₂FeX₄, Li(Al,Ga,In)X₄, Li₃(Al,Ga,In)X₆, and LiI, where X is at least one selected from the group consisting of F, Cl, Br, and I.

Another example of the halide solid electrolyte is a compound represented by LiₐMe_{b}Y_{c}Z₆, where a+mb+3c=6 and c>0 are satisfied, Me is at least one selected from the group consisting of metalloid elements and metal elements other than Li or Y Z is at least one selected from the group consisting of F, Cl, Br, and I. m represents a valence of Me. The “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se).

To enhance the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The halide solid electrolyte may be Li₃YCl₆ or Li₃YBr₆.

The second solid electrolyte material may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

When the solid electrolyte layer 22 includes the first solid electrolyte material, the negative electrode 23 may include a sulfide solid electrolyte to suppress reductive decomposition of the solid electrolyte material. The coating of the negative electrode active material with an electrochemically stable sulfide solid electrolyte can suppress the first solid electrolyte material from being brought into contact with the negative electrode active material. As a result, the internal resistance of the battery 100 can be reduced.

The second solid electrolyte material may be an oxide solid electrolyte.

Examples of the oxide solid electrolyte include:
(i) a NASICON-type solid electrolyte such as LiTi₂(PO₄)₃ or an element-substituted product thereof;
(ii) a perovskite-type solid electrolyte such as (LaLi)TiO₃;
(iii) a LISICON-type solid electrolyte such as Li₁₄ZnGe₄O₁₆, Li₄SiO₄, LiGeO₄, or an element-substituted product thereof;
(iv) a garnet-type solid electrolyte such as Li₇La₃Zr₂O₁₂ or an element-substituted product thereof; and
(v) Li₃PO₄ or an N-substituted product thereof.

The second solid electrolyte material may be an organic polymer solid electrolyte.

Examples of the organic polymer solid electrolyte include a compound of a polymer compound and a lithium salt.

The polymer compound may have an ethylene oxide structure. The polymer compound having an ethylene oxide structure may include a large amount of a lithium salt, and hence can further enhance the ionic conductivity.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from the above may be used alone. Alternatively, a mixture of two or more lithium salts selected from the above may be used.

At least one selected from the group consisting of the positive electrode 21, the solid electrolyte layer 22, and the negative electrode 23 may include a nonaqueous electrolyte solution, a gel electrolyte, or an ionic liquid in order to facilitate the exchange of lithium ions and enhance the output characteristics of the battery 100.

The nonaqueous electrolyte solution includes a nonaqueous solvent and a lithium salt dissolved in the nonaqueous solvent.

Examples of the nonaqueous solvent include a cyclic carbonate ester solvent, a chain carbonate ester solvent, a cyclic ether solvent, a chain ether solvent, a cyclic ester solvent, a chain ester solvent, and a fluorinated solvent. Examples of the cyclic carbonate ester solvent include ethylene carbonate, propylene carbonate, and butylene carbonate. Examples of the chain carbonate ester solvent include dimethyl carbonate, ethyl methyl carbonate, and diethyl carbonate. Examples of the cyclic ether solvent include tetrahydrofuran, 1,4-dioxane, and 1,3-dioxolane. The chain ether solvent is 1,2-dimethoxyethane or 1,2-diethoxyethane. Examples of the cyclic ester solvent include γ-butyrolactone. Examples of the chain ester solvent include methyl acetate. Examples of the fluorinated solvent include fluoroethylene carbonate, methyl fluoropropionate, fluorobenzene, fluoroethyl methyl carbonate, and fluorodimethylene carbonate. One nonaqueous solvent selected from the above may be used alone. Alternatively, a combination of two or more nonaqueous solvents selected from the above may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from the above may be used alone. Alternatively, a mixture of two or more lithium salts selected from the above may be used. The lithium salt has a concentration of, for example, 0.5 mol/L or more and 2 mol/L or less.

A polymer material impregnated with a nonaqueous electrolyte solution may be used as the gel electrolyte. Examples of the polymer material include polyethylene oxide, polyacrylonitrile, polyvinylidene fluoride, polymethyl methacrylate, and a polymer having an ethylene oxide bond.

Examples of the cation included in the ionic liquid include:
(i) an aliphatic chain quaternary salt, such as tetraalkylammonium or tetraalkylphosphonium;
(ii) an aliphatic cyclic ammonium, such as pyrrolidinium, morpholinium, imidazolinium, tetrahydropyrimidinium, piperazinium, or piperidinium; and
(iii) a nitrogen-containing heterocyclic aromatic cation, such as pyridinium or imidazolium.

Examples of the anion included in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may include a lithium salt.

At least one selected from the group consisting of the positive electrode 21, and the solid electrolyte layer 22, and the negative electrode 23 may include a binder to enhance the adhesion between particles.

Examples of the binder include polyvinylidene fluoride, polytetrafluoroethylene, polyethylene, polypropylene, an aramid resin, a polyamide, a polyimide, a polyamideimide, polyacrylonitrile, a polyacrylic acid, polyacrylic acid methyl ester, polyacrylic acid ethyl ester, polyacrylic acid hexyl ester, a polymethacrylic acid, polymethacrylic acid methyl ester, polymethacrylic acid ethyl ester, polymethacrylic acid hexyl ester, polyvinyl acetate, polyvinylpyrrolidone, a polyether, a polyethersulfone, hexafluoropolypropylene, styrene-butadiene rubber, and carboxymethyl cellulose. A copolymer may also be used as the binder. Examples of such a binder include a copolymer of two or more materials selected from the group consisting of tetrafluoroethylene, hexafluoroethylene, hexafluoropropylene, a perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from the above may also be used as the binder.

At least one selected from the positive electrode 21 and the negative electrode 23 may include a conductive additive in order to enhance electron conductivity.

Examples of the conductive additive include:
(i) graphites, such as natural graphite or artificial graphite;
(ii) carbon black, such as acetylene black or ketjen black;
(iii) conductive fibers, such as a carbon fiber or a metal fiber;
(iv) fluorinated carbon;
(v) a metal powder, such as aluminum;
(vi) a conductive whisker, such as a zinc oxide or a potassium titanate;
(vii) a conductive metal oxide, such as titanium oxide; and
(viii) a conductive polymer compound, such as polyaniline, polypyrrole, or polythiophene. The conductive additive of (i) or (ii) described above may be used for cost reduction.

### Modification Example 1

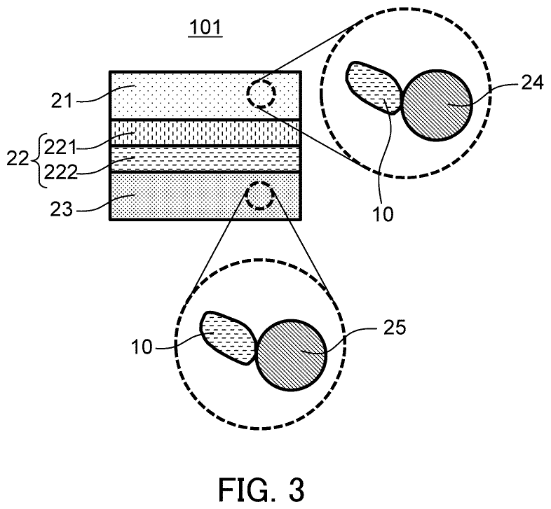

FIG. 3 shows a cross-sectional view of a battery 101 of Modification Example 1. The battery 101 has the same structure as that of the battery 100 shown in FIG. 2 except that the solid electrolyte layer 22 includes a first solid electrolyte layer 221 and a second solid electrolyte layer 222. Elements common to the battery 100 are denoted by the same reference numerals, and descriptions thereof are omitted.

The first solid electrolyte layer 221 is arranged between the positive electrode 21 and the second solid electrolyte layer 222. The second solid electrolyte layer 222 is arranged between the first solid electrolyte layer 221 and the negative electrode 23.

The solid electrolyte material included in the first solid electrolyte layer 221 may have a lower reduction potential than that of the solid electrolyte material included in the second solid electrolyte layer 222. Thus, the solid electrolyte material included in the second solid electrolyte layer 222 can be used without being reduced. As a result, the charge and discharge efficiency of the battery 101 can be enhanced. For example, the second solid electrolyte layer 222 may include the first solid electrolyte material. When the second solid electrolyte layer 222 includes the first solid electrolyte material, the first solid electrolyte layer 221 may include a sulfide solid electrolyte to suppress reductive decomposition of the solid electrolyte material. Thus, the charge and discharge efficiency of the battery 101 can be enhanced. The first solid electrolyte layer 221 may include the first solid electrolyte material. The first solid electrolyte material has high oxidation resistance, and hence the battery 101 having excellent charge and discharge characteristics can be achieved.

### Modification Example 2

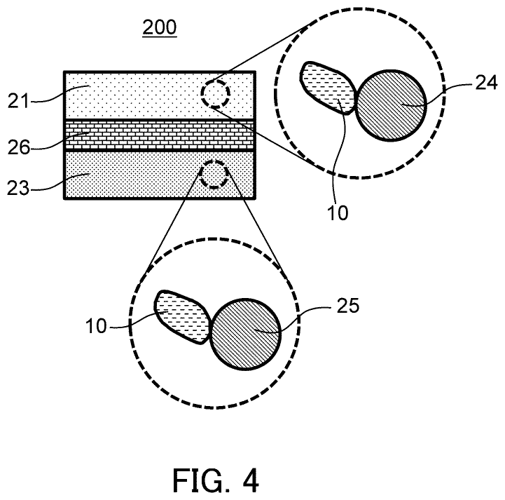

FIG. 4 shows a cross-sectional view of a battery 200 of Modification Example 2. The battery 200 has the same structure as that of the battery 100 shown in FIG. 2 except that the separator part is a separator impregnated with an electrolytic solution. Elements common to the battery 100 are denoted by the same reference numerals, and descriptions thereof are omitted.

A separator 26 has lithium ion conductivity. The material of the separator 26 is not particularly limited as long as the passage of lithium ions is allowed. Examples of the material of the separator 26 include a porous material. The separator 26 may have a membrane shape. When the separator 26 is a porous membrane, examples of the porous membrane include a woven fabric, a nonwoven fabric, a porous membrane made of a polyolefin resin, and a porous membrane made of glass paper obtained by weaving glass fiber into a nonwoven fabric.

The electrolytic solution may include at least one selected from the group consisting of a cyclic ether, a glyme, and a sulfolane. The electrolytic solution may include an ether. Examples of the ether include a cyclic ether and a glycol ether. The glycol ether may be a glyme represented by the composition formula CH₃(OCH₂CH₂)ₙOCH₃. In the above composition formula, n is an integer of 1 or more. The electrolytic solution may include a mixture of a cyclic ether and a glyme, or a cyclic ether as a solvent.

Examples of the cyclic ether include tetrahydrofuran (THF), 2-methyltetrahydrofuran (2MeTHF), 2,5-dimethyltetrahydrofuran, 1,3-dioxolane (1,3DO), and 4-methyl-1,3-dioxolane (4Me1,3DO). A mixture of one or more selected from the above may be used.

Examples of the glyme include monoglyme (1,2-dimethoxyethane), diglyme (diethylene glycol dimethyl ether), triglyme (triethylene glycol dimethyl ether), tetraglyme (tetraethylene glycol dimethyl ether), pentaethylene glycol dimethyl ether, and polyethylene glycol dimethyl ether. The glyme may be a mixture of tetraglyme and pentaethylene glycol dimethyl ether.

Examples of the sulfolane include 3-methylsulfolane.

The electrolytic solution may include an electrolyte salt. Examples of the electrolyte salt include lithium salts, such as LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, LiClO₄, and lithium bis(oxalate) borate. Lithium may be dissolved in the electrolytic solution.

The separator part may have a thickness of 1 μm or more and 1000 μm or less. When the separator part has a thickness of 1 μm or more, the positive electrode 21 and the negative electrode 23 are unlikely to short-circuit. When the separator part has a thickness of 1000 μm or less, the battery can operate at a high output.

Examples of the shape of the battery according to the second embodiment include a coin type, a cylindrical type, a prismatic type, a sheet type, a button type, a flat type, and a stacked type.

The battery according to the second embodiment may be produced by, for example, preparing a material for forming the positive electrode, a material for forming the solid electrolyte layer, and a material for forming the negative electrode, and producing a stack in which the positive electrode, the solid electrolyte layer, and the negative electrode are arranged in this order by a known method.

### OTHER EMBODIMENTS

### Appendix

The following techniques are disclosed by the description of the above embodiments.

### Technique 1

A method for producing a solid electrolyte material including Li, Ti, Al, and F, the method including: pulverizing a mixture including one or more compounds each having composition different from that of the solid electrolyte material and including Li, Ti, Al, and F, and a solvent; and drying a pulverized product obtained through the pulverization, wherein the one or more compounds include Li₂TiF₆.

According to the method for producing a solid electrolyte material according to Technique 1, the process window, for example, the range of the optimal pulverization time, can be expanded.

### Technique 2

The method for producing a solid electrolyte material according to Technique 1, wherein the one or more compounds include a Li-containing compound having composition different from that of Li₂TiF₆. According to such a configuration, the process window can be expanded.

### Technique 3

The method for producing a solid electrolyte material according to Technique 2, wherein the Li-containing compound includes LiF. According to such a configuration, the process window can be expanded.

### Technique 4

The method for producing a solid electrolyte material according to any one of Techniques 1 to 3, wherein the one or more compounds include an Al-containing compound. According to such a configuration, the process window can be expanded.

### Technique 5

The method for producing a solid electrolyte material according to Technique 4, wherein the Al-containing compound includes AlF₃. According to such a configuration, the process window can be expanded.

### Technique 6

The method for producing a solid electrolyte material according to any one of Techniques 1 to 5, wherein the solvent includes a compound having an ester group. According to such a configuration, the ionic conductivity of the solid electrolyte material can be enhanced.

### Technique 7

The method for producing a solid electrolyte material according to any one of Techniques 1 to 6, wherein the solvent includes at least one selected from the group consisting of γ-butyrolactone, propylene carbonate, butyl acetate, and tetralin. According to such a configuration, the ionic conductivity of the solid electrolyte material can be enhanced.

### Technique 8

The method for producing a solid electrolyte material according to any one of Techniques 1 to 7, wherein a ratio of an amount of substance of F to a total sum of amounts of substance of anions of the solid electrolyte material is 0.50 or more. According to such a configuration, the oxidation resistance of the solid electrolyte material is enhanced.

### Technique 9

The method for producing a solid electrolyte material according to any one of Techniques 1 to 8, wherein the solid electrolyte material is represented by the following formula (1): Li₆₋₍₄₋ₓ₎ₐ(Ti₁₋ₓAlₓ)ₐF₆ . . . (1), where 0<x<1 and 0<a≤1.5 are satisfied. According to such a configuration, the solid electrolyte material has a high ionic conductivity.

### Technique 10

A method for producing a solid electrolyte material including Li, Ti, Al, and F, the method including: heating a first mixture including two or more compounds including TiF₄ and LiF, and a solvent; pulverizing a second mixture including a composition obtained through the heating and an Al-containing compound; and drying a pulverized product obtained through the pulverization, wherein the composition includes Li₂TiF₆.

According to the method for producing a solid electrolyte material according to Technique 10, the process window, for example, the range of the optimal pulverization time, can be expanded.

### Technique 11

The method for producing a solid electrolyte material according to Technique 10, wherein the Al-containing compound includes AlF₃. According to such a configuration, the process window can be expanded.

### Technique 12

A method for producing a solid electrolyte material including Li, Ti, Al, and F, the method including: heating a mixture including three or more compounds including TiF₄, LiF, and an Al-containing compound, and a solvent; pulverizing a composition obtained through the heating; and drying a pulverized product obtained through the pulverization, wherein the composition includes Li₂TiF₆ and the Al-containing compound.

According to the method for producing a solid electrolyte material according to Technique 12, the process window, for example, the range of the optimum pulverization time, can be expanded.

### Technique 13

The method for producing a solid electrolyte material according to Technique 12, wherein the Al-containing compound includes AlF₃. According to such a configuration, the process window can be expanded.

### EXAMPLES

Hereinafter, the present disclosure will be described in more detail with reference to examples and comparative examples. The following are examples and do not limit the present disclosure.

### Example 1

### (Production of Solid Electrolyte Material)

In an argon atmosphere with a dew point of −60° C. or lower (hereinafter referred to as a “dry argon atmosphere”), LiF, Li₂TiF₆, and AlF₃ serving as raw material powders were prepared in a molar ratio of LiF:Li₂TiF₆:AlF₃=2.1:0.3:0.7. These raw material powders were loaded into a 45 cc planetary ball mill jar with 25 g of balls each having a diameter of 0.5 mm. γ-Butyrolactone (GBL) was dropped into the jar so that the solid content ratio was 30%. Here, the solid content ratio is calculated by {(mass of loaded raw materials)/(mass of loaded raw materials+mass of loaded solvent)}×100. A milling process was conducted with a planetary ball mill under the conditions of a rotation speed of 400 rpm for 2 hours. After the milling process, a slurry was obtained by separating the balls. The obtained slurry was dried with a mantle heater under a nitrogen flow under the conditions of 200° C. for 1 hour. A powder of a solid electrolyte material of Example 1 was obtained by pulverizing the obtained solid matter with a mortar. The solid electrolyte material of Example 1 had the composition of Li_{2.7}Ti_{0.3}Al_{0.7}F₆.

### (Evaluation of Ionic Conductivity)

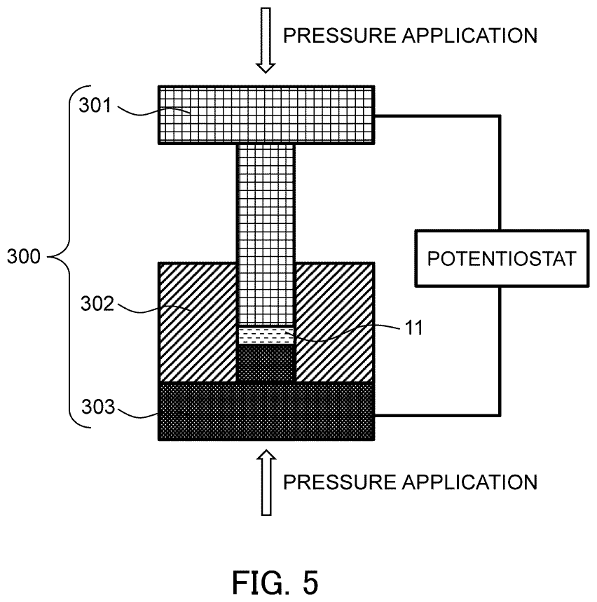

FIG. 5 is a schematic diagram of a pressure-molding die 300 used for evaluating the ionic conductivity of the solid electrolyte material.

The pressure-molding die 300 included an upper punch 301, a die 302, and a lower punch 303. The die 302 was made of polycarbonate, which is insulating. The upper punch 301 and the lower punch 303 were made of stainless steel, which is electronically conductive.

The pressure-molding die 300 shown in FIG. 5 was used to evaluate the ionic conductivity of the solid electrolyte material of Example 1 by the following method.

In a dry atmosphere with a dew point of −30° C. or lower, the pressure-molding die 300 was filled with a powder 11 of the solid electrolyte material of Example 1. Inside the pressure-molding die 300, a pressure of 400 MPa was applied to the powder 11 of the solid electrolyte material with the upper punch 301 and the lower punch 303.

While the pressure was applied, the upper punch 301 and the lower punch 303 were connected to a potentiostat (VSP-300 manufactured by Bio-Logic SAS) equipped with a frequency response analyzer. The upper punch 301 was connected to a working electrode and a potential measurement terminal. The lower punch 303 was connected to a counter electrode and a reference electrode. The impedance of the powder 11 of the solid electrolyte material was measured at room temperature by electrochemical impedance measurement.

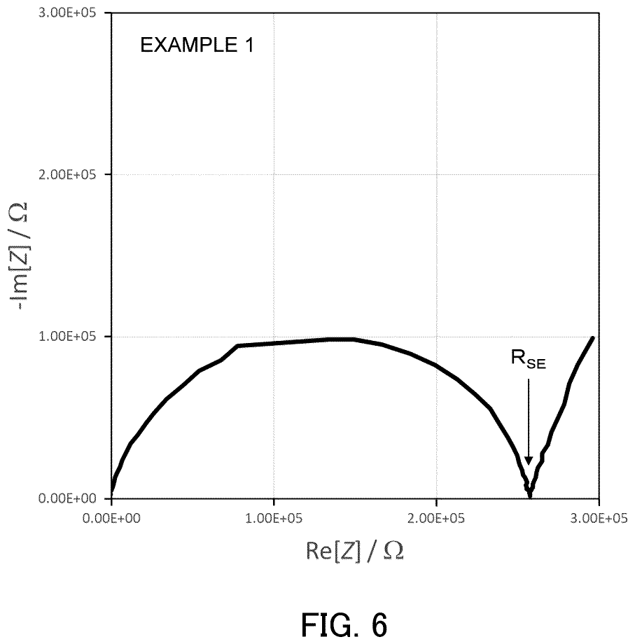

FIG. 6 is a graph showing a Cole-Cole plot obtained by the impedance measurement on the solid electrolyte material of Example 1.

In FIG. 6, a real value of an impedance at the measurement point where the absolute value of the phase of a complex impedance was smallest was defined as the resistance value of the solid electrolyte material to ion conduction. For the real value, see an arrow RSE shown in FIG. 6. An ionic conductivity a was calculated from the resistance value by the following mathematical formula (4).

$$σ = {( {R}_{S E} \times S / t )}^{- 1} \qquad ( 4 )$$

In the mathematical formula (4), S represents the contact area of the solid electrolyte material with the upper punch 301. That is, S is equal to the cross-sectional area of the cavity of the die 302 in FIG. 5. RSE represents the resistance value of the solid electrolyte material in the impedance measurement. t represents the thickness of the solid electrolyte material. That is, t represents the thickness of the layer formed of the powder 11 of the solid electrolyte material in FIG. 5.

The ionic conductivity is a value measured at 25° C.

### Examples 2 to 6

### (Production of Solid Electrolyte Material)

Powders of solid electrolyte materials of Examples 2 to 6 were each obtained by the same method as in Example 1 except that the pulverization time was changed as shown in Table 1. The solid electrolyte materials of Examples 2 to 6 each had the composition of Li_{2.7}Ti_{0.3}Al_{0.7}F₆.

### Comparative Examples 1 to 3

### (Production of Solid Electrolyte Material)

LiF, TiF₄, and AlF₃ serving as raw material powders were prepared in a molar ratio of LiF:TiF₄:AlF₃=2.7:0.3:0.7. The pulverization time was changed as shown in Table 1. Powders of solid electrolyte materials of Comparative Examples 1 to 3 were each obtained by the same method as in Example 1 except for the above. The solid electrolyte materials of Comparative Examples 1 to 3 each had the composition of Li_{2.7}Ti_{0.3}Al_{0.7}F₆.

### (Evaluation of Ionic Conductivity)

The ionic conductivity of each of the solid electrolyte materials of Examples 2 to 6 and Comparative Examples 1 to 4 was measured by the same method as in Example 1. The results are shown in Table 1.

### (Evaluation of BET Specific Surface Area)

The BET specific surface area of each of the solid electrolyte materials of Example 4 and Comparative Example 1 was measured by the method described above. The results are shown in Table 1.

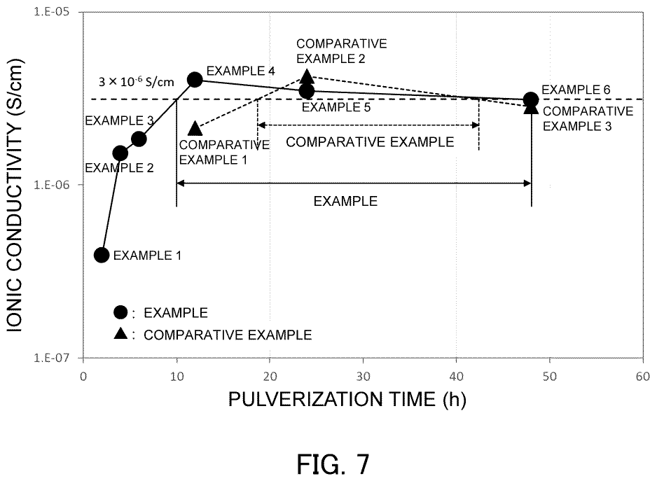

FIG. 7 shows changes in ionic conductivity with changes in pulverization time for the solid electrolyte materials of Examples 1 to 6 and Comparative Examples 1 to 3.

TABLE 1

| | Pulverization | BET specific | Ionic |
|---|---|---|---|
| | time | surface area | conductivity |
| | (h) | (m²/g) | (S/cm) |
| Example 1 | 2 | — | 3.91 × 10⁻⁷ |
| Example 2 | 4 | — | 1.52 × 10⁻⁶ |
| Example 3 | 6 | — | 1.83 × 10⁻⁶ |
| Example 4 | 12 | 32.1 | 4.03 × 10⁻⁶ |
| Example 5 | 24 | — | 3.48 × 10⁻⁶ |
| Example 6 | 48 | — | 3.09 × 10⁻⁶ |
| Comparative Example 1 | 12 | 21.5 | 2.13 × 10⁻⁶ |
| Comparative Example 2 | 24 | — | 4.24 × 10⁻⁶ |
| Comparative Example 3 | 48 | — | 2.83 × 10⁻⁶ |

### <Consideration>

As shown in FIG. 7, the ionic conductivity of each of the solid electrolyte materials of the examples reached 3×10⁻⁶ μS/m in a pulverization time of 10 hours. In contrast, in each of the solid electrolyte materials of the comparative examples, a pulverization time of 18 hours was required for the ionic conductivity to reach 3×10⁻⁶ μS/m. In addition, as shown in FIG. 7, each of the solid electrolyte materials of the examples maintained an ionic conductivity of 3×10⁻⁶ μS/m or more even when the pulverization time exceeded 45 hours, specifically at the time point of 48 hours. In contrast, in each of the solid electrolyte materials of the comparative examples, when the pulverization time exceeded 43 hours, the ionic conductivity dropped to less than 3×10⁻⁶ μS/m. That is, while the range of the optimum pulverization time of the examples was 38 hours between 10 hours and 48 hours, the range of the optimum pulverization time of the comparative examples was 25 hours between 18 hours and 43 hours. Thus, according to the production method of the present disclosure, the process window was able to be expanded.

As shown in Table 1, the pulverization time of the solid electrolyte material of Example 4 was 12 hours, which was the same as the pulverization time of the solid electrolyte material of Comparative Example 1. However, while the BET specific surface area of the solid electrolyte material of Example 4 satisfied 25 m²/g or more, the BET specific surface area of the solid electrolyte material of Comparative Example 1 did not satisfy 25 m²/g or more. From the results, it is conceived that the expansion of the process window is easily achieved by conducting the pulverizing step such that the BET specific surface area of the solid electrolyte material is 25 m²/g or more.

The pulverization time of the solid electrolyte material of Example 5 was 24 hours, which was the same as the pulverization time of the solid electrolyte material of Comparative Example 2. Although the ionic conductivity of the solid electrolyte material of Example 5 showed a slightly lower value than the ionic conductivity of the solid electrolyte material of Comparative Example 2, the object of the present invention is the expansion of the process window, and hence the ionic conductivity is not a problem as long as its value is equal to or greater than a certain value.

### Example 4

### (Production of Battery)

A battery was produced by the following method using the solid electrolyte material of Example 4, which had the highest ionic conductivity among Examples 1 to 6.

In a dry argon atmosphere, the solid electrolyte material of Example 4 and LiCoO₂ serving as an active material were prepared so that the volume ratio was 30:70. These materials were mixed in an agate mortar. Thus, a positive electrode mixture was obtained.

In an insulating cylinder having an inner diameter of 9.5 mm, Li₃PS₄ (57.41 mg), the solid electrolyte material of Example 4 (26 mg), and the positive electrode mixture (9.1 mg) were stacked in this order, and a pressure of 300 MPa was applied thereto. Thus, a stack consisting of a first electrolyte layer, a second electrolyte layer, and a positive electrode was formed. That is, the second electrolyte layer included the solid electrolyte material of Example 4. The first electrolyte layer had a thickness of 450 μm, and the second electrolyte layer had a thickness of 150 μm.

Subsequently, metal Li (thickness: 200 μm) was stacked on the first electrolyte layer. The stack thus obtained was subjected to application of a pressure of 80 MPa to form a negative electrode.

Subsequently, current collectors made of stainless steel were attached to the positive electrode and the negative electrode, and current collector leads were attached to the current collectors.

Lastly, an insulating ferrule was used to block the inside of the insulating cylinder from the outside air atmosphere to hermetically seal the cylinder. Thus, the battery of Example 4 was produced.

### (Charge and Discharge Test)

The initial charge and discharge characteristics of the battery of Example 4 were measured by the following charge and discharge test.

The battery was placed in a thermostatic chamber set at 85° C.

The battery was charged at a current density of 13.5 μA/cm² until the voltage reached 4.2 V. The current density is equivalent to a 0.01 C rate.

Subsequently, the battery was discharged at a current density of 13.5 μA/cm² until the voltage reached 2.5 V.

As a result of the charge and discharge test, the battery of Example 4 had an initial discharge capacity of 867 μAh.

### Comparative Example 4

### (Production of Battery)

LiBF₄ was used as the solid electrolyte material of Comparative Example 4. A battery of Comparative Example 4 was produced by the same method as in Example 4 except that the solid electrolyte material of Comparative Example 4 was used as the solid electrolyte used for the positive electrode mixture and the electrolyte layer.

### (Charge and Discharge Test)

A charge and discharge test was conducted on the battery of Comparative Example 4 by the same method as in Example 4.

The initial discharge capacity of the battery of Comparative Example 4 was 0.01 μAh or less. That is, the battery of Comparative Example 4 failed in both charge and discharge.

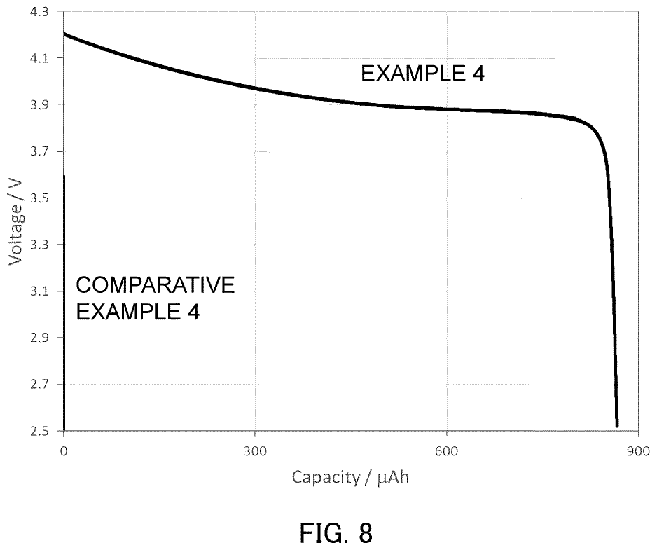

FIG. 8 is a graph showing the initial discharge characteristics of the batteries of Example 4 and Comparative Example 4.

### <Consideration>

The battery according to Example 4 was charged and discharged at 85° C. In contrast, the battery according to Comparative Example 4 failed in both charge and discharge. That is, the battery according to Example 4 had excellent charge and discharge characteristics.

As described above, according to the method for producing a solid electrolyte material of the present disclosure, the process window, for example, the range of the optimum pulverization time, can be expanded. In addition, a battery using the solid electrolyte material produced by the production method can have excellent charge and discharge characteristics.

### INDUSTRIAL APPLICABILITY

The solid electrolyte material produced by the method for producing a solid electrolyte material according to the present disclosure can be used for, for example, a battery (e.g., an all-solid-state battery or a liquid battery).

What is claimed is:

1. A method for producing a solid electrolyte material including Li, Ti, Al, and F, the method comprising:
pulverizing a mixture including one or more compounds each having composition different from that of the solid electrolyte material and including Li, Ti, Al, and F, and a solvent; and
drying a pulverized product obtained through the pulverization, wherein
the one or more compounds include Li₂TiF₆; and
wherein the pulverizing is conducted such that the BET specific surface area of the solid electrolyte material is 25 m²/g or more.

2. The method for producing a solid electrolyte material according to claim 1, wherein
the one or more compounds include a Li-containing compound having composition different from that of Li₂TiF₆.

3. The method for producing a solid electrolyte material according to claim 2, wherein
the Li-containing compound includes LiF.

4. The method for producing a solid electrolyte material according to claim 1, wherein
the one or more compounds include an Al-containing compound.

5. The method for producing a solid electrolyte material according to claim 4, wherein
the Al-containing compound includes AlF₃.

6. The method for producing a solid electrolyte material according to claim 1, wherein
the solvent includes a compound having an ester group.

7. The method for producing a solid electrolyte material according to claim 1, wherein
the solvent includes at least one selected from the group consisting of γ-butyrolactone, propylene carbonate, butyl acetate, and tetralin.

8. The method for producing a solid electrolyte material according to claim 1, wherein
a ratio of an amount of substance of F to a total sum of amounts of substance of anions of the solid electrolyte material is 0.50 or more.

9. The method for producing a solid electrolyte material according to claim 1, wherein
the solid electrolyte material is represented by the following formula (1): 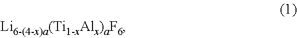
0<x<1 and 0<a≤1.5 are satisfied.

10. A method for producing a solid electrolyte material including Li, Ti, Al, and F, the method comprising:
heating a first mixture including two or more compounds including TiF₄ and LiF, and a solvent;
pulverizing a second mixture including a composition obtained through the heating and an Al-containing compound; and
drying a pulverized product obtained through the pulverization, wherein
the composition includes Li₂TiF₆.

11. The method for producing a solid electrolyte material according to claim 10, wherein
the Al-containing compound includes AlF₃.

12. A method for producing a solid electrolyte material including Li, Ti, Al, and F, the method comprising:
heating a mixture including three or more compounds including TiF₄, LiF, and an Al-containing compound, and a solvent;
pulverizing a composition obtained through the heating; and
drying a pulverized product obtained through the pulverization, wherein
the composition includes Li₂TiF₆ and the Al-containing compound.

13. The method for producing a solid electrolyte material according to claim 12, wherein the Al-containing compound includes AlF₃.
